(19) United States
(12) Patent Application Publication
(10) Pub. No.: US 2009/0056573 A1
(43) Pub. Date: Mar. 5, 2009

(54) INK-SUPPLY CARTRIDGE FOR PRINTER ROLLER

(76) Inventors: Rainer Wieland, Wurzburg (DE); Peter Schmitt, Wurzburg (DE)

Correspondence Address: K.F. ROSS P.C., 5683 RIVERDALE AVENUE, SUITE 203 BOX 900, BRONX, NY, 10471-0900, US

(21) Appl. No.: 12/202,539

(22) Filed: Sep. 2, 2008

(30) Foreign Application Priority Data
Sep. 4, 2007 (DE) 102007041758.8

(51) Int. Cl. B41F 31/00

(52) U.S. Cl. 101/350.6

(57) ABSTRACT

A printer has a press frame and a roll rotatable in the frame about an axis and having a radially outwardly directed roll surface. An ink cartridge has a housing having a pair of support plates juxtaposed with and angularly spaced along the roll surface. Doctor blades supported on the support plates have outer edges resiliently engageable with the surface. One of the doctor blades is shiftable on the housing between an open position and a closed position with the outer edges engaging each other. Interengageable formations on the housing and on the press frame are movable between a use position retaining the housing on the press frame with the outer edges engaging the surface and a removal position. An actuating element is shiftable to move the one doctor blade from the open position to the closed position and shift the formations from the use position into the removal position.

### FIELD OF THE INVENTION

The present invention relates to a printer. More particularly this invention concerns a removable ink cartridge for feeding ink to a roll of a printer.

### BACKGROUND OF THE INVENTION

A standard printer has an ink-transfer or anilox roll that is fed ink from a cartridge hopper or well that sits atop the transfer roll and that fits tightly against the roll so that a body of ink held in the cartridge sits atop the roll. Such a cartridge has a pair of doctor blades that have outer edges that engage the roll along lines parallel to the axis thereof, with the space between these lines forming a downwardly open ink-feed mouth. As the roll rotates, its surface is wetted with excess ink scraped off the roll by the downstream doctor blade.

Such a cartridge is frequently formed as a removable cartridge so that it can be removed and either clean or replaced with another cartridge having different ink. To make this possible as described in U.S. Pat. No. 7,234,396, it is known to make one of the blades movable so that, rather than having to empty the cartridge before removing it, it is possible to move this one blade over the roll surface to engagement with the other blade, thereby closing the ink-feed mouth. Then the cartridge can be lifted away with no significant leakage.

The ink cartridge typically has a housing formed by two short axially spaced end walls and two long axially extending side or support walls. The doctor blades sit against the support walls with their edges projecting inward past their inner edges to engage the press roll. Optionally, a side element may directly comprise a doctor bar. In any case, the element on which a doctor blade is arranged or attached is referred to as the doctor bar.

In another system a separate blade or shutter can be slid into the cartridge to close its mouth. This blade is removed for operation and the ink is able to reach the ink transfer roll. If it is necessary to change the ink, this blade is inserted again and reseals the opening to the ink transfer roll, such that the ink insert containing the ink may be removed. The disadvantage of the type described above is that the ink that has gotten on the doctor blades in the course of normal operation remains there even after the ink insert has been removed and, in addition, ink gets between the ink insert and the ink cartridge such that, after the exterior region of the ink insert has been removed, the interior region of the ink cartridge must also be cleaned.

In addition, an increased amount of ink remains on the ink transfer roll in the region of the opening of the ink cartridge to the ink transfer roll because the additional insertion blade runs in guide slots in the ink insert and therefore is unable to scrape off the ink transfer roll. This also results in the disadvantage of an increased cleaning expense for the ink transfer roll itself and an associated increase in ink usage, in particular in cases of frequent ink changes.

Moreover, it is also known from prior art to seal the ink cartridge off from the ink transfer roll by means of a doctor blade that is attached to a doctor bar and is movable along with the doctor bar, with the doctor bar and the doctor blade attached thereto being moved toward the opposing doctor blade. Such an ink cartridge is known, for example, from above-cited U.S. Pat. No. 7,234,396. The disadvantage of this type of sealing mechanism is that, before removal of such an ink cartridge from a press frame on a printing unit, service personnel muse ensure that the ink cartridge is tightly sealed. Otherwise the removal will cause ink to accidentally leak from the ink cartridge. Moreover, it is disadvantage that the cartridge volume of the ink cartridge is significantly reduced by the displacement of the doctor bar along with the doctor blade, such that an overflow danger exists, particularly in the case of a completely or almost completely full ink cartridge, which may cause ink to flow into the printing press in an uncontrolled fashion.

### OBJECTS OF THE INVENTION

It is therefore an object of the present invention to provide an improved ink-cartridge hopper for printer roller.

Another object is the provision of such an improved ink-cartridge hopper for printer roller that overcomes the above-given disadvantages, in particular that avoids the disadvantages listed above and automatically closes on removal from the printing unit, thus preventing operating errors to a large extent.

A further object of the invention is to provide an improved ink cartridge of the generic type that allows the ink to be changed in a quick and problem-free manner without any ink remaining in the ink cartridge being able to leak into the printing press and, at the same time, minimizing the cleaning effort.

Yet another object of the invention is to create an ink cartridge that allows an ink change to be conducted even when the ink cartridge is completely full, and to create an ink cartridge by means of which it is possible to change ink with minimal ink loss.

### SUMMARY OF THE INVENTION

The instant invention is used in a printer having a press frame and a roll rotatable in the frame about an axis and having a radially outwardly directed roll surface. The ink cartridge according to the invention has a housing having a pair of support plates juxtaposed with and angularly spaced along the roll surface. Respective doctor blades supported on the support plates have outer edges resiliently engageable with the surface so that a body of ink can be held between the blades and engage the surface between the edges of the blades. One of the doctor blades is shiftable on the housing between an open position with its outer edge spaced from the outer edge of the other doctor blade and a closed position with the outer edges engaging each other. Interengageable formations on the housing and on the press frame are movable between a use position retaining the housing on the press frame with the outer edges engaging the roll surface and a removal position freeing the housing for separation from the press frame. A movable actuating element is shiftable to, when moved between an unactuated position and an actuated position, shift the one doctor blade from the open position to the closed position and shift the formations from the use position into the removal position.

In other words a mechanism has the actuating element by means of which, when activated, the opening between the doctor blades may be closed and by whose actuation after or during the closing process the ink cartridge may be moved relative to a fixed press frame in a printing unit, in particular be unlocked by the movement, and removed from this press frame. Thus, immediately before removal or during removal of the ink cartridge from the ink transfer roll, the ink cartridge is completely and automatically sealed off from the ink transfer roll, such that no printing ink is able to leak from the ink cartridge toward the ink transfer roll.

Because the invention is preferably used in printing presses that use rolls for ink transfer, the term “roll” will be used in the following in place of “ink transfer roll” without limiting the general scope of the invention.

Here, provision may be made for the actuating element to be manually activated or activated by another device. For example, the actuating element may be embodied as a lever.

In one embodiment, provision is made according to the invention for the two doctor blades to be movable relative to one another so both doctor blades may be movable at the same time, or one doctor blade may be fixed and the other doctor blade may be movable relative to it. Correspondingly, by appropriately selecting the respective movements, it is possible to move the two edges of the doctor blade toward one another on the one hand, such that the opening is made smaller by the relative movement between the edges of the doctor blades until this opening is completely closed once the doctor blades are touching

Here in particular, provision may be made for at least one of the doctor blades to be guided over the surface of the roll with its outer edge and, in this manner, to scrape the printing ink off of the surface of the roll and move it back into the ink cartridge.

In a preferred embodiment, provision may be made for the ink cartridge to have one movable doctor blade and one fixed doctor blade. Here, the movable doctor blade serving for closing the opening may form the upstream scraper relative to the roll, with this upstream scraper being opposite the downstream doctor blade. Thus, in this embodiment, an ink cartridge has two doctor blades, one of which is movable.

In another embodiment, the ink cartridge may have a fixed downstream or working doctor blade and a fixed upstream or upstream doctor blade (relative to the rotation direction of the roll), as well as at least one separate doctor blade for sealing the ink cartridge. Such a doctor blade may be described as a sealing doctor blade. In a preferred embodiment, this sealing doctor blade may, if only one is provided, be parallel to one of these two fixed doctor blades, in particular arranged preferably parallel to the upstream doctor blade on the inside of the ink cartridge.

In order to operate the ink cartridge in the printing unit, it is necessary for this ink cartridge to be fixed in the press frame in such a way that the opening formed by the doctor blades rests tightly against the roll and the ink may be transferred from the ink cartridge onto the roll. Provision is further made according to the invention for the ability of the movements mentioned above to be performed by a mechanism attached to or in the ink cartridge by means of which, on the one hand, the ink cartridge is sealed against the roll in the manner mentioned above and, on the other hand, at the same time, the ink cartridge is released from its fixation and the ink cartridge may thus be removed from the press frame mentioned above and therefore from its use position.

Here, in a preferred embodiment, the opening formed in the ink cartridge between the edges of the doctor blades is sealable by a relative movement of at least one of the doctor blades and/or at least one additional sealing doctor blade relative to the other in such a way that the ink on the roll inside the ink cartridge is scraped off and the scraped-off ink is returned to the ink cartridge and such that, preferably, the interior volume of the ink cartridge remains at least essentially constant. Here, the volume is viewed essentially as constant if it is altered by less than 10% by the ink cartridge being closed.

Here, the volume remaining at least essentially constant when the ink cartridge is sealed by the movement of at least one doctor blade is preferably accomplished in that, upon actuating of the mechanism, the doctor bars provided in the ink cartridge remain fixed in place and only at least one of the doctor blades is moved. These doctor blades are normally thin and flexible and thus displace very little or only a negligible amount of volume inside the ink cartridge when they move as compared to ink supplies known from the prior art in which a doctor blade is moved along with a doctor bar.

Moreover, the reduction in volume may be kept low in that, when it is moved, a doctor blade is displaced parallel to its use position or at least essentially parallel to a fixed doctor blade, whereby, upon its movement, it is pushed against the outer surface of the roll with a outer edge. Upon the continued translation of the edge of the doctor blade, the doctor blade bends due to its flexibility and therefore runs near the outer surface of the roll over its entire motion.

If a separate movable sealing doctor blade is provided, it may first move along the inner or upper surface of the fixed doctor blade, for example, the upstream doctor blade, arranged below it and then along the outer surface of the roll at least up to the outer edge of the second fixed doctor blade, for example, the downstream doctor blade. Thus the sealing doctor blade, on the one hand, scrapes off the surface of the roll, thus directing the printing ink located thereon into the interior of the ink cartridge and, on the other hand, sealing the ink cartridge against the roll.

In all embodiments, provision may be made for the outer edge of at least one of the doctor blades to be moved toward the outer edge of the opposing doctor blade and for the edges of the doctor blades to touch or overlap one another, thus sealing the ink cartridge against the roll.

Provision is made according to the invention for the ink cartridge, on removal from the roll, to be automatically movable toward the roll, in that the doctor blades and especially the edges of the doctor blades and/or the sealing doctor blade(s) are moved toward one another in straight-line and/or rotary movement, thus sealing the ink cartridge against the roll.

A mechanism that accomplishes the above and ensures an essentially constant volume may be implemented, for example, by a movable doctor blade to be functionally connected to a shaft mounted in a rotatable fashion that is arranged parallel to the edge of the doctor blade. Rotation of the shaft around its rotational axis may be caused by the actuating element and, by this rotation, the outer edge of the movable doctor blade may be moved toward the outer edge of the opposing doctor blade and rest in its end position on/against the outer edge of the opposing doctor blade in such a way that the opening between the doctor blades is sealed, in particular with the outer edge of the movable doctor blade scraping the excess printing ink from the surface of an roll of a printing group in the course of the closing process.

As mentioned above, because in this case only the doctor blade is shifted and the mechanism for effecting this movement rotates, this mechanism remains essentially fixed in place relative to the ink cartridge and its actuation does not cause any substantial change in volume because the rotating roll remains in place, as do the doctor bars.

Here, in a preferred embodiment, a movable doctor blade can be attached to the shaft and, in the open position, at least partially be wrapped or wound around the shaft and be unwound from the shaft during rotation of the shaft, in particular with the doctor blade being moved during the closing movement inside along the doctor bar or, in the other alternative, along a fixed doctor blade. Thus, upon actuation, the movable doctor blade unwinds and slides toward the opposing doctor blade like a Venetian blind. Thus, it is seen as particularly advantageous for a movable doctor blade to be embodied as a spring steel blade because this material has the flexibility necessary to repeatedly be wound and unwound on the shaft of the mechanism.

The use of such a mechanism also allows locking of the ink cartridge in a fixed press frame on a printing group to be released and the ink cartridge to be removed with a rotational movement by the shaft. To this end, at least one transversely projecting locking arm may be provided on the shaft, in particular with a ball coupling on its outer end, that may be brought into a functional connection with a corresponding recess or seat of the press frame.

Rotation of the shaft, therefore, pivots a locking arm and orbits its ball-coupling end at a radial spacing around the shaft. Because the end is supported on the press frame, the ink cartridge is thus automatically released from the press frame, in particular with it being pivoted around one or more bearing points on the opposite side of the ink cartridge. To this end, the ink cartridge may also have fixed locking arms on the side opposite this mechanism that may be brought into engagement with corresponding elements, for example, recesses, on the press frame. Here, it is preferable for all fixed locking arms and corresponding elements of the press frame to be located on a line in order to define a rotational axis around which the lifting of the ink cartridge is accomplished when the mechanism is activated. The ink cartridge is closed at the same time the mechanism is activated.

In a preferred embodiment, provision may be made for the outer end of such a locking arm to be displaceable radially and prestressed radially outward, in particular by a spring. In this manner, it is possible for the spring force to hold the ink cartridge in the press frame and press it against the cylindrical roll outer surface, and also for the ink cartridge, upon passing the end of the locking arm facing the shaft, to snap into the press frame in the respective direction of movement via an imaginary connector line between two opposing bearing points of the ink cartridge.

Thus, conversely, by using a sealed ink cartridge in a press frame of a printer, the locking arm is brought into engagement with the press frame and, in the insertion movement, the shaft is rotated by the locking arm, so that the ink cartridge is opened and, at the same time, locked into the press frame.

Moreover, in the mechanism with a shaft as described above, it is preferable for provision to be made for this shaft to be arranged near one of the doctor blades, in particular above it, such that, during the movement, one doctor blade is wound and unwound in the intermediate space between the shaft and the doctor blade. In addition to the arrangement of a shaft for moving a doctor blade, provision may also be made for two opposing shafts to be used for moving two doctor blades toward one another, with at least one of the shafts also causing the locking into and releasing from the press frame.

Furthermore, provision may be made according to the invention for the doctor blades to seal off the ink cartridge from the end elements in an ink-tight fashion as soon as the ink cartridge has also been sealed against the ink transfer roll so as to prevent leakage of printing ink between the side element and the doctor blade.

In order to prevent this in the construction described above, provision may be made for a corresponding sealing device to be arranged on each side element, for example, in the form of an elastic closing element that laterally seals the ink cartridge from leaking ink; it must especially have a sealing effect immediately before and after removal of the ink cartridge from the press frame, for example, in that a flexible bodies is inserted as a sealing element in the side elements of the ink cartridge in the region of the end walls, which material is pressed, for example, by a respective device against the respective edges of the doctor blades and/or doctor bars immediately before the removal of the ink cartridge from the press frame, particularly by deformation and/or displacement of the material.

This may occur, for example, in that, on the side of each piece of flexible bodies facing away from the ink cartridge, particularly therefore inside each side element, an eccentric roller cam is provided whose outer surface acts on the flexible in such a way that, in a particular position of the respective eccentric roller cam, it is pressed against the corresponding edges of the doctor blades and/or doctor bars.

It is also possible according to the invention for the positioning of the eccentric roller cams to also occur via the mechanism for moving the doctor blades, such that, when the ink cartridge is sealed against the roll, the side elements are also sealed against the side edges of the doctor blades, thus resulting in an ink cartridge that is fully sealed off from the printing group.

### BRIEF DESCRIPTION OF THE DRAWING

The above and other objects, features, and advantages will become more readily apparent from the following description, reference being made to the accompanying drawing in which:

FIG. 1 is a schematic end view of the ink cartridge and associated structure according to the invention;

FIG. 2 is a view like FIG. 1 of a variant of the FIG. 1 apparatus;

FIGS. 3a-3d are small scale vies like FIG. 1 illustrating the ink cartridge according to the invention;

FIG. 4 is a perspective view of a detail of the ink cartridge; and

FIGS. 5 and 6 are partial sectional views illustrating the ink cartridge during normal use and after removal.

### SPECIFIC DESCRIPTION

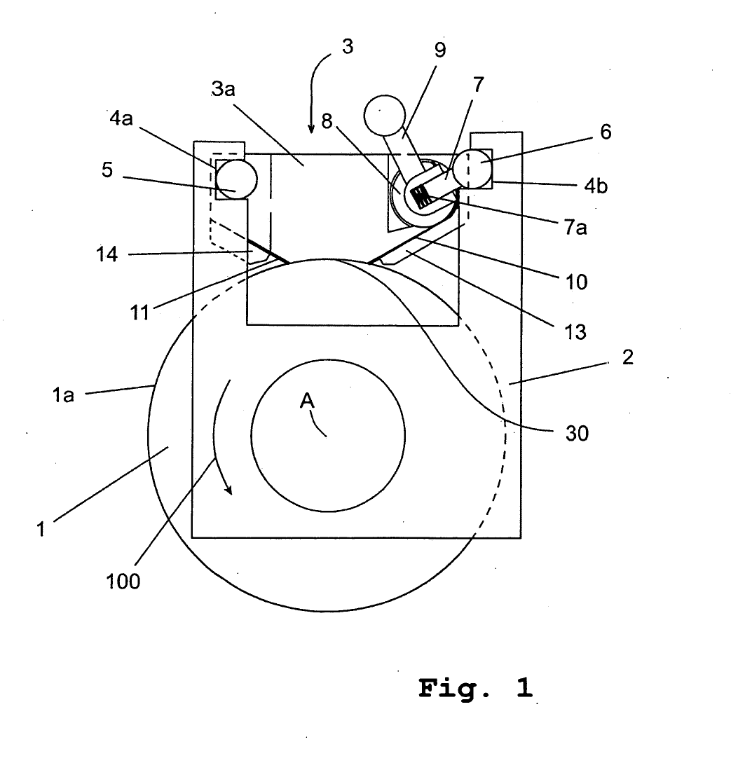

As seen in FIG. 1 an ink-transfer or anilox roll 1 has a cylindrical outer surface 1a centered on an axis A and can rotate in a direction 100 about this axis A in a relatively stationary frame or press frame 2. The outer surface 1a is typically formed with a uniform array of shallow pockets but is, as stated, otherwise cylindrical. It is used to transfer ink to further rolls that apply it to a web or sheet.

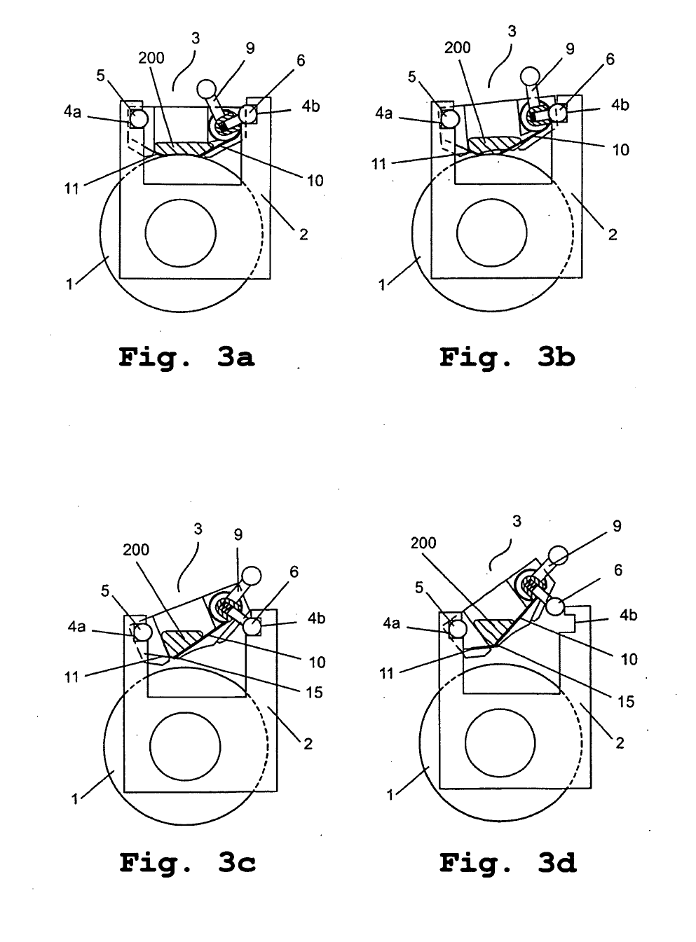

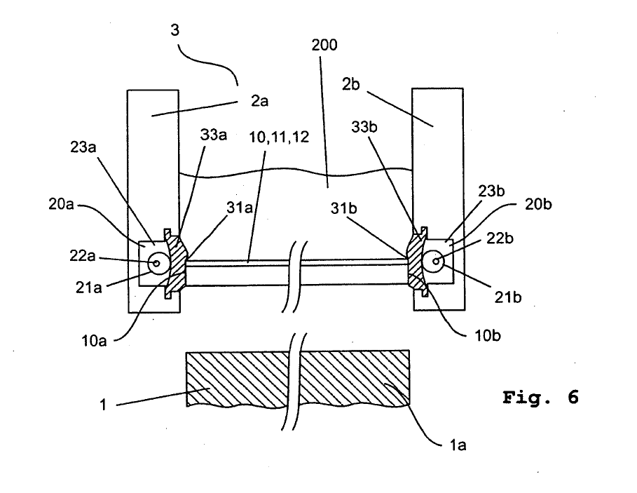

An ink cartridge 3 defines a compartment or chamber 3a adapted to hold a body 200 (FIGS. 3a-3d) of ink and having a predetermined volume. This cartridge has a frame forming a pair of relatively fixed and rigid plates 13 and 14 that are angularly spaced along the surface and that are downwardly engaged by respective movable and fixed doctor blades 10 and 11 made of thin and somewhat flexible stainless-steel sheet material. The blades 10 and 11 have confronting outer edges that bear radially inward against the surface 1a and that define a downwardly open mouth 30 through which the ink of the body 200 can engage the surface 1a directly. Ends of the plates 13 and 14 are fixed in end plates 2a and 2b (FIGS. 5 and 6) that extend perpendicular to the axis A and that form with the plates 13 and 14 a housing of the cartridge 3.

As the roll 1 rotates in the direction 100, excess printing ink is scraped off of the surface 1a by the fixed doctor blade 11. Here, the ink cartridge 3 itself is secured in the press frame 2 such that it may easily be removed, for example, for cleaning purposes or for changing ink.

To this end, the press frame 2 has recesses 4a and 4b formed as square-section grooves open toward each other and both extending parallel to the axis A. Corresponding elements 5 and 6 attached to the ink cartridge 3 may engage and, on the one hand, fix the ink cartridge in its use position and, on the other hand, if necessary, are able to exert an additional contact pressure by the doctor blades 10 and 11 on the surface 1a of the roll 1, for example, via corresponding pressure springs 7a. Moreover, the doctor blades 10 and 11 themselves as mentioned above are made of flexible stainless steel so that they are also able to exert a certain radial inward contact pressure on the surface 1a of the roll 1 by virtue of their own springiness.

In order to remove the ink cartridge 3 from its use position and thus also from the printing group and the press frame 2, according to the invention the opposing element 6 is at least two balls attached to respective movable locking arm 7 extending radially from a rotationally mounted shaft 8 and prestressed outward from the shaft 8 by a compression spring 7a so as to engage in the respective recess 4b in such a way that the ink cartridge, on the one hand, is held in a first use position by the spring 7a and when the shaft 8 is rotated around its rotational axis that extends parallel to the axis A the ink cartridge 3 can be levered out of its use position via the locking arm 7 that may move radially relative to the shaft 8 and the other element 5. The balls 6 are aligned on an axis parallel to the axis A, and the element 6 can be a simple shaft 5 seated in its ends in the end plates 2a and 2b (FIGS. 5 and 6). The ends of the shaft 5 are fixed in the plates 2a and 2b and the ends of the shaft 8 are journaled in them.

To this end, a lever 9 is furthermore attached to and extends radially from the shaft 8 so as to be able to remove the ink cartridge 3 from its use position manually or via an unillustrated drive. In order to limit the rotation of the lever 8, it may be practical for corresponding rotation abutments to be provided and thus for corresponding end positions for the rotational movement to be defined.

According to the invention the doctor blade 10 is attached to the rotatable shaft 8, either directly or via a mount, in such a way that upon the rotation of the shaft 8 during removal of the ink cartridge from the press frame 2 the outer edge of the doctor blade 10 is moved toward the outer edge of the other doctor blade 11 and, at least at the end of such movement, the outer edges of the doctor blades 10 and 11 come to rest against one another or one over the other in such a way that the opening 30 to the roll 1 is completely closed and no ink is able to leak from the ink cartridge toward the roll 1. Then the ink cartridge may be removed from the printing press in a problem-free fashion. The mouth 30 is closed. During the closing process, the outer edge of the movable doctor blade 10 slides over the cylindrical surface 1a of the roll 1 and, in so doing, scrapes off the printing ink and moves it up into the chamber 3a of the ink cartridge 3.

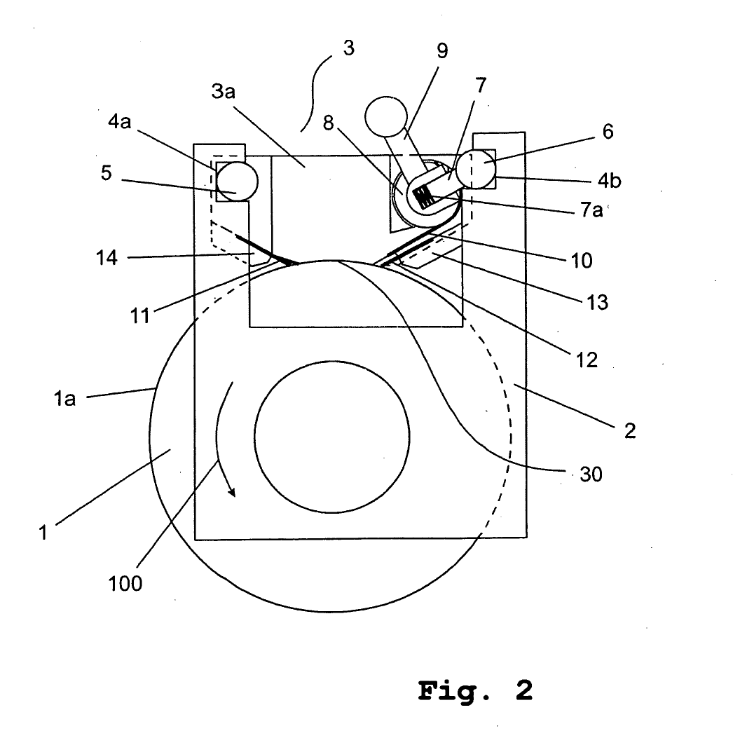

Another embodiment of an ink cartridge according to the invention is shown in FIG. 2, which has the same essential features of the first embodiment OF FIG. 1. In addition, however, FIG. 2 shows another fixed doctor blade 12 attached to the plate 13, such that the plates 13 and 14 with the fixed doctor blades 11 and 12 attached thereto and the corresponding lateral blades 11 and 12 form a conventional ink cartridge. Here, as shown in FIG. 1, the blade 10 is fastened to the rotational shaft 8 directly or via a mount such that its outer edge does not rest against the surface 1a of the roll in the use position of the ink cartridge and has no influence on the printing process.

Upon removal of the ink cartridge from the printing press and therefore upon the rotation of the shaft 8 around its rotational axis, the doctor blade 10 is displaced with its outer edge toward the outer edge of the doctor blade 11 in such a way that, on the one hand, it slides along the side of the doctor blade 12 facing the interior of the ink cartridge and thus scrapes off the printing ink adhering to it and then slides along the surface 1a of the roll 1 in the region of the opening 30 and thus scrapes off the surface 1a of the roll 1. In its end position, as described in conjunction with FIG. 1, the edges of the doctor blades 10 and 11 lie against one another or one on top of the other in such a way that the opening 30 of the ink cartridge 3 is completely closed. This guarantees that, even after the removal of the ink cartridge 3 from the printing press, no printing ink, in particular no ink located in the use position between the doctor blades 10 and 12, is able to leak uncontrollably.

The sequence of movements involved in the removal of the ink cartridge 3 according to FIG. 1 from its holder is shown schematically in FIGS. 3a, 3b, 3c, and 3d. FIG. 3a shows the ink cartridge 3 in its normal use position, in which the doctor blade 10 rests in a first position against the surface 1a of the roll 1 in such a way that the opening 30 is formed between the ink cartridge 3 and the surface 1a of the roll. The depressions or cavities in the roll 1 may be filled with printing ink 200 and a normal, problem-free printing operation may take place.

The beginning of removal of the ink cartridge 3 from its press frame 2 is shown in FIG. 3b. Rotation of the shaft 8 by the lever 9 lifts the ink cartridge 3 out of the holder 2 and, at the same time, the outer edge of the doctor blade 10 is displaced toward the doctor blade 11. As the outer edge of the blade 10 slides downstream (in direction 100) over the surface 1a, the upstream side of the cartridge moves radially outward and the entire cartridge pivots about an axis defined by the balls 5 in the groove 4a. This causes the opening 30 to shrink and the ink located on the surface 1a of the roll 1 to be transported completely into the interior of the ink cartridge 3 because the outer edge of the doctor blade 10 glides over the surface 1a of the roll 1 and in so doing scrapes it off.

FIG. 3c then shows the situation immediately before an end position of the rotational movement of the shaft 8 in which the opening 30 has already been closed and the outer edges of the doctor blades 10 and 11 bear sealingly against each other at a contact line 15. Due to the springiness of the flexible doctor blades and the selected approach angles of the doctor blades 10 and 11 relative to one another, the outer edges of the doctor blades 10 and 11 press against one another, resulting in excellent sealing at the contact line 15.

Finally, FIG. 3d shows the ink cartridge 3 largely removed and out of engagement with the roll 1, with the shaft 8 having come to rest in its end position. In order to secure the ink cartridge 3 against undesired opening, it may be practical for an additional locking mechanism to be provided on the shaft 8, which is not actuated until insertion of the ink cartridge 3 into the press frame 2 corresponding to FIG. 3d or 3c and which allows the shaft 8 to rotate around its axis.

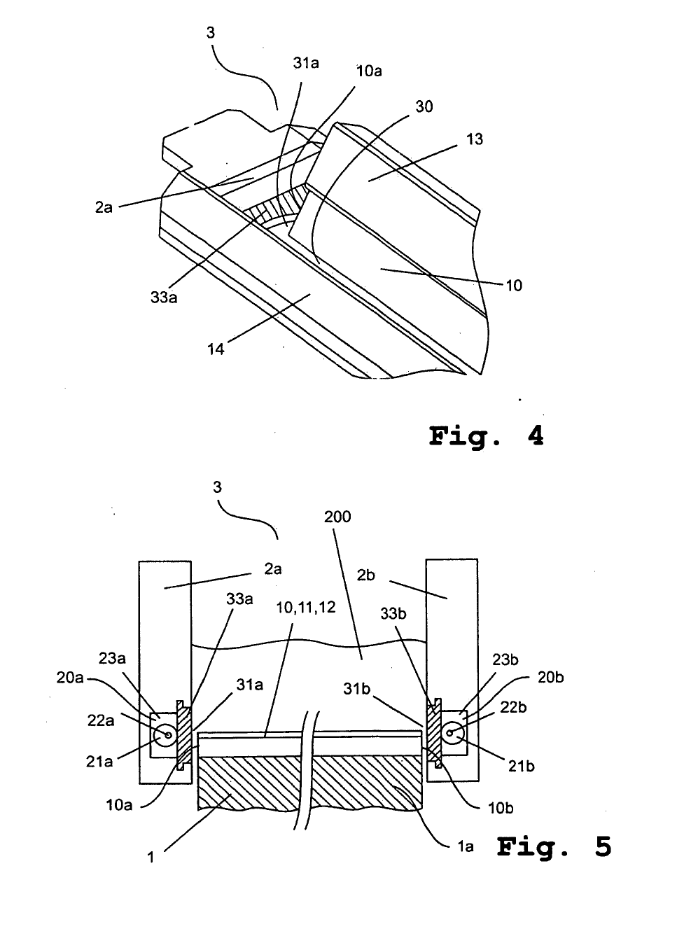

Moreover, in order to seal between end edges 10a and 10b of the blades 10 and 11 and the end walls 2a and 2b there are flexible bodies 33a and 33b carried in the end walls and engageable with the end edges of the blades 10 and 11 as shown in FIGS. 4 to 6. Due to mechanical imbalances in the roll 1, frictional wear on the doctor blades 10 and 11, and other outside influences, and in particular in the case of a movable doctor blade 11, it is not possible for the doctor blades 10 and 11 to be connected in a fixed manner to the end walls 2a and 2b. Thus gaps 31a and 31b always exist between the end walls 2a and 2b and the end edges 10a and 10b of the doctor blade 10 through which printing ink may leak uncontrollably.

Therefore, if the ink cartridge is sealed as described by means of a movable doctor blade 10, it is still possible for undesired leakage of printing ink to occur through these gaps 31a and 31b mentioned above in its finished state. Therefore, provision is made according to the invention for the flexible bodies 33a and 33b set in the end walls 2a and 2b to be deformed by means of respective actuators 20a and 20b, at least when the ink cartridge 3 is sealed, in such a way that the axially confronting faces of the flexible bodies 33a and 33b are pressed against the edges 10a and 10b of the doctor blade and thus the gaps 31a and 31b are closed as shown in FIG. 6.

The devices 20a and 20b may have cylindrical cams 21a and 21b eccentrically journaled at respective axes 22a and 22b in a recesses 23a and 23b of the end walls 2a and 2b, with the outer surfaces of these cams 21a and 21b acting on the flexible bodies 33a and 33b. In a first position of the cylinders 21a and 21b, as shown in FIG. 5, no force or only minimal force is exerted on the flexible bodies 33a and 33b, such that they deform not at all or only to a negligible degree and the gaps 31a and 31b are formed. On the other hand, in a second position of the cylinders 21a and 21b, as shown in FIG. 6, force is exerted on the flexible bodies 33a and 33b, which deform to the extent that they are pressed against the edges 10a and 10b of the doctor blade 10 and the gaps 31a and 31b are closed, preventing leakage from the chamber 3a.

In this embodiment, it is advisable for the actuators 20a and 20b to be coupled with the mechanism for removing the ink cartridge, that is with the shaft 8, such that the ink cartridge 3 is completely sealed with one single combined movement.

With regard to all embodiments, it should be noted that the technical features cited in conjunction with one embodiment may be used not only in that specific embodiment, but also in the other embodiments. All technical details of this invention specification are to be considered essential to the invention and may be used alone or in any combination.

We claim:

1. In combination with a printer having
a press frame, and
a roll rotatable about an axis on the press frame and having a radially outwardly directed roll surface, an ink cartridge comprising:
a housing having a pair of support plates juxtaposed with and angularly spaced along the roll surface;
respective doctor blades supported on the support plates and having outer edges resiliently engageable with the surface, whereby a body of ink can be held between the blades and engage the surface between the edges of the blades, one of the doctor blades being shiftable on the housing between an open position with its outer edge spaced from the outer edge of the other doctor blade and a closed position with the outer edges engaging each other;
interengageable formations on the housing and on the press frame movable between a use position retaining the housing on the press frame with the outer edges engaging the surface and a removal position freeing the housing for separation from the press frame;
a movable actuating element; and
means connecting the actuating element to one of the formations and to one of the doctor blades for, when moved between an unactuated position and an actuated position, shifting the one doctor blade from the open position to the closed position and shifting the formations from the use position into the removal position.

2. The combination defined in claim 1 wherein the other doctor blade is generally fixed on the housing.

3. The combination defined in claim 2, further comprising a second fixed doctor blade adjacent the one movable doctor blade.

4. The combination defined in claim 1 wherein the actuating element includes a shaft extending generally parallel to the axis, connected to the one movable doctor blade, and pivotal to shift the one movable doctor blade between the removal and use positions.

5. The combination defined in claim 4 wherein one movable doctor blade is at least partially wound around the shaft in the open position.

6. The combination defined in claim 5 wherein the one movable blade is a flexible spring-steel sheet.

7. The combination defined in claim 1 wherein rotation of the shaft about its axis shifts the movable plate and the one formation.

8. The combination defined in claim 4 wherein the other formation is a seat on the support shaft has at least one arm projecting transversely from the shaft and having an outer end forming the one formation and fittable in the seat.

9. The combination defined in claim 8 wherein the outer end is formed as a ball.

10. The combination defined in claim 8 wherein the arm has two parts and includes a spring pressing the two parts apart to prestress the ball into the seat in the use position.

11. The combination defined in claim 10 wherein in the use position the ball presses at least partially radially outward against the seat.

12. The combination defined in claim 10 wherein the shifting of the one formation and of the one doctor blade are both synchronized by rotation of the shaft.

13. The combination defined in claim 1, further comprising
axially spaced flexible bodies carried on the housing and shiftable between outer positions generally disengaged from axial end edges of the doctor blades and inner positions bearing axially against the axial end edges.

14. The combination defined in claim 13, further comprising;
respective actuators engaged between the flexible bodies and the housing and operable to shift the bodies between the inner and outer positions.

15. In combination with a printer having
a roll rotatable about an axis and having a radially outwardly directed cylindrical outer surface and
a press frame forming a pair of axially extending grooves open toward each other, the roll being journaled in the frame offset from the grooves,
an ink cartridge comprising:
a housing displaceable between a use position closely juxtaposed with the roll and a removed position spaced from the roll, the housing having a pair of axially extending support plates juxtaposed with and angularly spaced along the roll surface in the use position and a pair of axially spaced end plates fixed to the support plates;
an element on the housing fittable in one of the grooves of the press frame;
respective doctor blades supported on the support plates and having outer edges resiliently engageable with the surface and end edges juxtaposed with the end plates in the use position of the housing, whereby a body of ink can be held between the blades and engage the surface between the edges of the blades, one of the doctor blades being movable on the housing between an open position with its outer edge spaced from the outer edge of the other doctor blade and a closed position with the outer edges engaging each other;
a pivotal shaft journaled in the end plates and having a transversely extending arm with an outer end fittable in the other of the grooves, one of the doctor blades being connected to the shaft offset from an axis of the shaft; and
means for pivoting the shaft between a use position with the outer end engaged in the other groove and retaining the housing on the press frame in the use position with the outer edges engaging the surface and a removal position with the outer end disengaged from the other groove and the housing freed for separation from the press frame and for shifting the one doctor blade from the open position to the closed position on shifting of the formations from the use position into the removal position.
